(19) United States
(12) Patent Application Publication
(10) Pub. No.: US 2012/0241386 A1
(43) Pub. Date: Sep. 27, 2012

(54) MULTI-FUNCTION WATER TREATMENT

(76) Inventor: Kaiss ALAHMADY, Richardson, TX (US)

(21) Appl. No.: 13/427,837

(22) Filed: Mar. 22, 2012

Related U.S. Application Data
(60) Provisional application No. 61/466,447, filed on Mar. 22, 2011.

(51) Int. Cl. C02F 1/52; B01D 21/30; B01D 21/01; C02F 9/04; C02F 9/12

(52) U.S. Cl. 210/709; 210/702; 210/721; 210/729; 210/202; 210/143

(57) ABSTRACT

The present invention relates to processes, methods, apparatuses, and systems for multi-function water treatment to condition feed water from various sources. The multi-function treatment includes seven stages, where the chemical content of the entered feed water is conditioned, then broken, then oxidized, then de-foamed, then clarified, then de-scaled, and then filtered via each stage.

### RELATED APPLICATIONS

This application claims priority to U.S. Provisional Patent Application 61/466,447 entitled “Multi-Function Water Treatment” filed Mar. 22, 2011, which is incorporated by reference in its entirety.

### BACKGROUND

The present invention relates to processes, methods, apparatuses, and systems for multi-function water treatment to condition feed water from various sources. The feed water is a solution containing any number of materials but the primarily content of the solution is water. Materials or substances other than the water itself in the solution can be contaminant or non-contaminate materials or substances. The materials or substances can be in any phase in the form of solid, liquid, gas, or combination.

The feed water can be raw or unprocessed water from open water bodies, lakes, rivers, or ground water. The feed water can be sourced from fresh, brackish, saline, or brine water sources with any concentration of total dissolved solids or dissolved salts. The feed water of the present invention can be rejected, treated, processed, or concentrated water that has been generated as a result of some sort of treatment or processing of feed water. For example, the feed water can be a reject or concentrate from any water treatment process such as filtration, reverse osmosis, chemical reactors, or biological-based processes. Furthermore, the feed water can be inputted into the multi-function water treatment of this invention from any stage or process that combine water from any sources and treatment from any process, such as reject from reverse osmosis process of brackish water, or reject from a cooling tower.

The result of the multi-function water treatment of this invention is fresh water that can be used for agriculture, industrial, domestic, household, recreational, environmental and animal and human drinking purposes. When the outcome of the Multi-function water treatment is fresh water for human drinking, the characteristics of the treated water comply with drinking water standards including microbial, chemical, radiological, and acceptability aspects.

### BRIEF DESCRIPTION OF THE DRAWINGS

FIG. 1 illustrates one embodiment of the multi-function water treatment of the present invention comprising seven stages, where the chemical content of the entered feed water is conditioned, then broken, then oxidized, then de-foamed, then clarified, then de-scaled, then filtered through the stages.

FIG. 2 illustrates an alternative embodiment of the invention wherein the sequences of the functions are different from the embodiment illustrated in FIG. 1, specifically, wherein the water is clarified prior to oxidation.

FIG. 3 illustrates another alternative embodiment of the invention wherein the de-foaming step occurs between the de-scaling step.

FIG. 4 illustrates a flow control assembly to control the flow of the water solution within flow networks.

FIG. 5 illustrates yet another alternative embodiment of the invention, wherein a fraction or all of the water solution flow via flow control apparatus is transferred to stage via a flow control.

FIG. 6 illustrates a control module that may be connected to a sensing module in an embodiment of the invention.

FIG. 7 illustrates another embodiment of the invention wherein multiple systems are connected, but are able to act as completely independent stations to treat feed water to a specific capacity or a quality of feed water per day.

### DETAILED DESCRIPTION

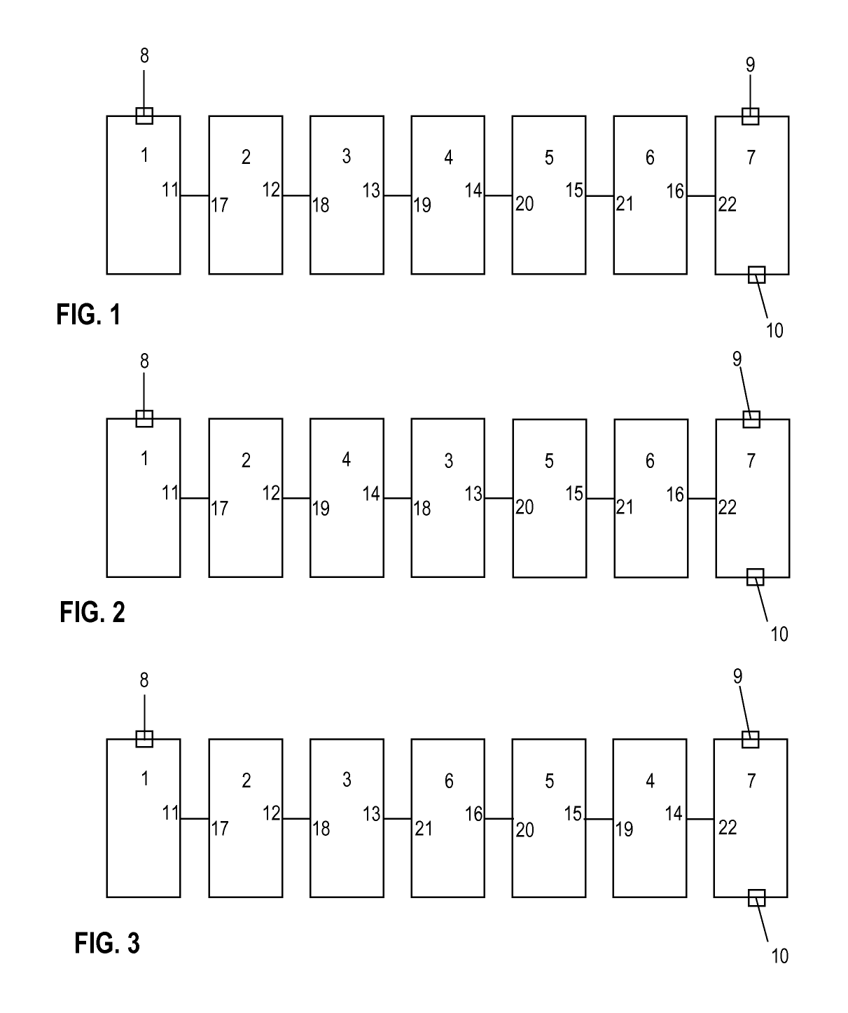

The multi-function water treatment of the present invention addresses at least two functions impacting the characteristics of water solution being treated. The number of stages in the Multi-function water treatment of the present invention can vary, but at least two stages exist. FIG. 1 illustrates an embodiment of the multi-function water treatment of the present invention. The feed water entering through flow control device (8) is passed through a number of stages where each stage provides distinguished function that impacts the conditions of the water passing through the stage such that the entered water into the stage is different in characteristics than the water exiting the stage. In FIG. 1, the treated water of the multi-function water treatment exits stage (7) through a flow control device (10) and (9). The water exiting through a flow control device (10) represents the permeate of the treated water of the multi-function water treatment while the water exiting though a flow control device (9) represents a reject water of the multi-function water treatment.

The quality of the water through (10) is always greater than the quantity of water through (9). The control devices (8), (9), and (10) can adjust the flow rate and thus the quantity of the water entering or exiting a stage. For example, control device (8) can control the flow rate of the feed water into stage (1), control device (10) can control the flow rate of treated water out of stage (7), and control device (9) can control the flow rate out of reject out of stage (7). FIG. 1 shows a multi-function treatment with seven stages, where the chemical content of the entered feed water is conditioned, then broken, then oxidized, then de-foamed, then clarified, then de-scaled, then filtered via stages (1), (2), (3), (4), (5), (6), and (7); respectively. The feed water enters into the first stage (1) through a flow control device (8) and exists through flow control devices (9, 10).

The flow of water throughout the stages of the multi-function water treatment preferably go in sequence from stage to stage; the stages that are not the first or the last each has at least two flow directing apparatus one is designed to receive the water flow in and the second is designed to facilitate the water flow out. The receiving and existing water flow apparatus can provide fixed or variable water flow rates.

The feed water entered via flow control device (8) is a water solution with any number of elements or compounds dissolved or undisclosed in the water into stage (1). The latter provides a conditioning function where one or more of solution temperature, solution pH, or dissolved gases in the solution is altered via the function of stage (1) during specific period of time. For example, the function of stage (1) can cause the water solution temperature to increase by one or more degrees through a heater, reduce the solution pH via the addition of a chemical, and/or remove a percentage of dissolved Carbon Dioxide (CO₂) via the employment of an apparatus or system to remove dissolved gases employing forced degasification, vacuum degasification, or membranes contactors. The objective of stage (1) is to condition or pre-treat the feed water solution such as the impact of the function of the next stage can be maximized

The next function of the embodiment of FIG. 1 is breaking the chemical structure of contaminants in the feed water solution in stage (2) such that either coagulation can be started in the solution, the rate of coagulation can be increased, or both. Stage (2) can be an electro-coagulation reactor where in the water solution treated in stage (1) exits via apparatus (11), enters via apparatus (17), receives treatment in stage (2) during a period of time, and exists stage (2) via apparatus (17). A mass of the water solution in stage (2) can be stagnating for a period of time such that no flow occurred within apparatus (11, 12) or one of them, or have a continuous flow through stage (2).

The electro-coagulation function of stage (2) is achieved through a reactor wherein coagulation is brought by the reduction of the net surface charge to a point where ions and colloidal particles can approach closely enough to allow aggregation. The reduction of the surface charge is a consequence of the decrease of the repulsive potential of the electrical double layer by the presence of an electrolyte having opposite charge. The coagulant is generated in situ by electrolytic oxidation of an appropriate anode material. Charged ionic species are caused to react with ions having opposite charge or with flocculent of metallic hydroxides generated within the solution by introducing highly charged polymeric metal hydroxide species. These species neutralize the electrostatic charges on suspended solids and droplets to facilitate agglomeration or coagulation and resultant separation from the aqueous phase.

For example, stage (2) can include an electro-coagulation reactor assembling an electrolytic cell with at least one anode and one cathode connected to an external power source. The anode material will electrochemically corrode due to oxidation, while the cathode will be subjected to deposition of a layer of oxide on its surface. The reactor essentially consists of pairs of conductive metal plates in parallel acting as electrodes. The electrodes can be of the same or of different materials. Power polarity can be switched between the electrodes within specific time intervals to distribute corrosion evaluable among the plates and/or to optimize the breaking function provided by stage (2).

In one embodiment, flow rate of water solution via stage (2) can be zero for a first period of time, and greater than zero for a second period of time allowing a mass, or specific quality, of water solution in the stage to be in stagnation during the first period of time while experiencing a flow rate during the second period of time. Furthermore, the condition of the water within stage (2) during the first period of time can include a flow inside (internal flow) the stage but no flow through flow apparatus (17, 12). The length of the first period, the length of the second period, the frequency of the first and second periods, and the distribution in occurrence of the first and second periods of time can be random, of any pattern, driven by a schedule, driven by one or more operating parameters, or combination. For example, the pattern of occurrence of the first and second period can be correlated to the current flowing through the electro-coagulation reactor, the current and voltage applied to the plates of the electro-coagulation reactor from an external power source, or a value of an operating parameter of stage (2) or the water passing through stage (2) or any other stage or apparatus of the present invention.

The next function of the embodiment of FIG. 1 of the multi-function water treatment of the present invention is removal of metal oxides from the water solution flowing into stage (3) wherein the water solution treated in stage (2) exits via apparatus (12), enters via apparatus (18), receives treatment in stage (3) during a period of time, and exists stage (3) via apparatus (13). Stage (3) can be any oxides removal process or apparatus that does not introduce gases, or associated with minimal production of gases such that an overall addition of buoyancy (through the addition of bubbles) into the water solution by the end of the process is minimal or zero. The purpose of stage (3) function is rather to accelerate the removal of metal oxides, such as iron oxides; or accelerate other types of chemical reactions, which result in the removal of metal oxides from the water solution. A mass of the water solution in stage (3) can be locally stagnating within stage (3) for a period of time such that no flow occurred within apparatus (18, 13) or one of them, or have a continuous flow through stage (3). Stage (3), for example, can include an apparatus of cascading steps design where the water solution flows in a thin film downward a series of steps such that turbulent flow of the solution increases dissolved oxygen in the water solution during the process.

The next function of the embodiment of FIG. 1 of the multi-function water treatment is the de-foaming function for the removal of foams and bubbles from the water solution for the purpose of reducing buoyancy from the water solution flowing into stage (4) wherein the water solution treated in stage (3) exits via apparatus (13), enters via apparatus (19), receives treatment in stage (4) during a period of time, and exists stage (4) via apparatus (14). Stage (4) can be any tank with an agitator creating disturbance within the water solution in the tank and resulting in reducing the overall buoyancy or overall gases content of the solution water. The agitator can be a propeller, circulating, or oscillating water jets driven by an electrical motor, electrical pump, or air-driven motor or pump. A mass of the water solution in stage (4) can be locally stagnating within stage (4) for a period of time such that no flow occurred within apparatus (19, 14) or one of them, or have a continuous flow through stage (4).

The next function of the embodiment of FIG. 1 of the multi-function water treatment of the present invention is clarification function of the water solution primarily via settlement of suspended solids in the water solution flowing into stage (5) wherein the water solution treated in stage (4) exits via apparatus (14), enters via apparatus (20), receives treatment in stage (5) during a period of time, and exists stage (5) via apparatus (15). Stage (5) can be a separate clarification apparatus coupled with a settler, or multistage apparatus including various clarifier/settler combinations. A mass of the water solution in stage (5) can be locally stagnating within stage (5) for a period of time such that no flow occurred within apparatus (20, 15) or one of them, or have a continuous flow through stage (5).

The next function of the embodiment of FIG. 1 of the multi-function water treatment of the present invention is de-scaling function of the water solution via removal of scaling agents or substances that may cause scaling or precipitation on porous or semi-porous materials, surfaces, or membranes. The purpose of the de-scaling function in stage (6) is either to reduce the scaling ability or potential of substances in the water solution such that no perception occurs on a surface of concern within a subsequent stage of the present embodiment or on a surface of concern within a further processing of the water solution. The water solution flowing into stage (6) is the output of the stage (5) that exits via apparatus (15), enters via apparatus (21), receives treatment in stage (6) during a period of time, and exist stage (6) via apparatus (16). Stage (6) can be any process or apparatus that mechanically remove scaling potential, such as by reducing the concentration of calcium carbonate via lattice mapping to a level that prevent precipitation of calcium carbonate in a subsequent treatment of the water solution. A mass of the water solution in stage (6) can be locally stagnating within stage (6) for a period of time such that no flow occurred within apparatus (21, 16) or one of them, or have a continuous flow through stage (6).

The next function of the embodiment of FIG. 1 of the multi-function water treatment of the present invention is the filtration function of the water solution via removal of materials and substances from the water solution via a filtration process. The purpose of the filtration function in stage (7) is to remove sufficient materials and substances from the water solution by filtration such that the output water is conditioned to comply with specific parameters for a terminal use without further treatment needed, or conditioned for a further processing, such as a reverse osmosis process. The filtration function within stage (7) can be achieved with any filtration method or process, such as microfiltration, ultra-filtration, nano-filtration, or lower filtration media or membrane of smaller porosity. The water solution flowing into stage (7) is the output of the stage (6) that exits via apparatus (16), enters via apparatus (22), receives treatment in stage (7) during a period of time, and exist stage (7) via apparatus (10 and 9). A mass of the water solution in stage (7) can be locally stagnating within stage (7) for a period of time such that no flow occurred within apparatus (22, 9, and 10) or one of them, or have a continuous flow through stage (7).

The feed water provided to the multi-function treatment of the present invention can be a water solution that has been processed to some degree. For example, the water solution fed into flow control apparatus (8) can be a reject from a reverses osmosis process, reject from a nano-filtration process, permeate from a micro-filtration process, or combination of water generated from one or more treatment processes.

The water solution flow is transferred throughout the stages and the connections between any two of the stages via a solution containment apparatus, such as pipes and tanks. The driving force that causes the water solution to flow can be either gravity or one or more pumps.

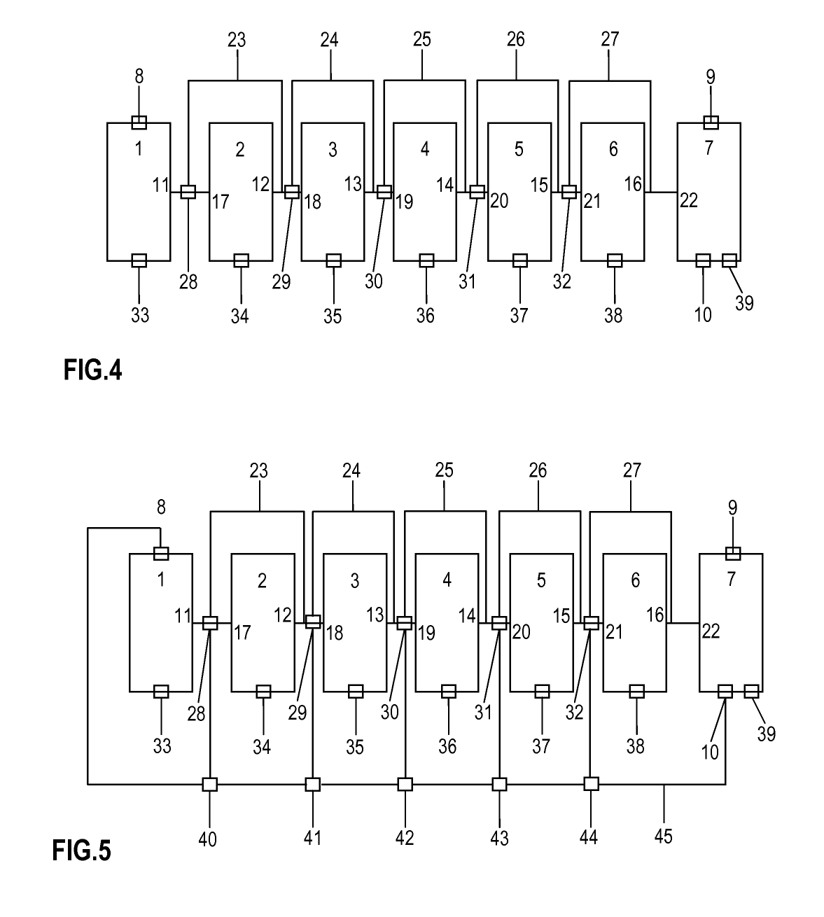

The sequence of the functions within the multi-function water treatment maybe different than FIG. 1. For example, stage (4) function maybe introduced in the sequence prior to stage (3) (FIG. 2); or stage (6) maybe introduced in the sequence prior to stage (4) (FIG. 3). In this embodiment, one or more functions, and corresponding stages, may be introduced in the sequence such any combination of the functions may be introduced in the sequence. In another embodiment of the present invention, a portion of the water solution flow exiting a first stage can be transferred to bypass a second stage where the second stage is a subsequent to the first stage. In FIG. 4, a flow control assembly or apparatus (28) enables the transfer of the water solution existing stage (1) via flow apparatus (11) to bypass stage (2) by joining the flow out of stage (2). The flow via the flow network (23) is directional such that no flow is backed into the control assembly (28). The flow via flow network (23) is terminated outside stage (2) such that no portion of the flow in flow network (23) is transferred to stage (2). The control assembly (28) can cause none, all, or a portion in between of the flow out of (11) to be transferred within flow network (23) therefore resulting is a percentage of 0-100% to bypass stage (2). This allow to manage the impact of the treatment function associated with stage (2) on the water solution, for example, a treatment function can be completely eliminated or allowed on a specific percentage of the water solution.

FIG. 4 also shows flow control assemblies or apparatuses (29, 30, 31, and 32) to control the flow of the water solution within flow networks (24, 25, 26, and 27); respectively. FIG. 4 further shows flow exit apparatus (33, 34, 35, 36, 37, 38, and 39) which provide an additional flow out for stages (1, 2, 3, 4, 5, 6, and 7); respectively in addition to the flow control apparatus (11, 12, 13, 14, 15, 16, 9, and 10); respectively. Flow control via (33, 34, 35, 36, 37, 38, and 39) can be used for any need that requires flow out of a stage such as for cleaning, backwashing, or draining.

FIG. 5 shows an embodiment of the present invention, a fraction or all of the water solution flow via flow control apparatus (10) is transferred to stage (1) via flow control (8). Furthermore, none, fraction, or all of the water solution flow via flow control apparatus (10) can be transfer to any of stages via water solution transfer flow network (45). Flow into stages are altered using flow controllers (44, 43, 42, 41, and 40) for flow into stages (6, 5, 4, 3, 2, and 1); respectively. Each of the controllers (44, 43, 42, 41, and 40) can cause none, fraction, or all of the flow out of apparatus (10) to be transferred into the corresponding stage. Control assemblies or apparatus (29, 30, 31, and 32) can be any flow control device or element that can direct zero to 100% of an entering flow stream from one or more opening into one or two opening, one transferring the flow into a flow network for the bypass effect and the second carries the flow into a next stage.

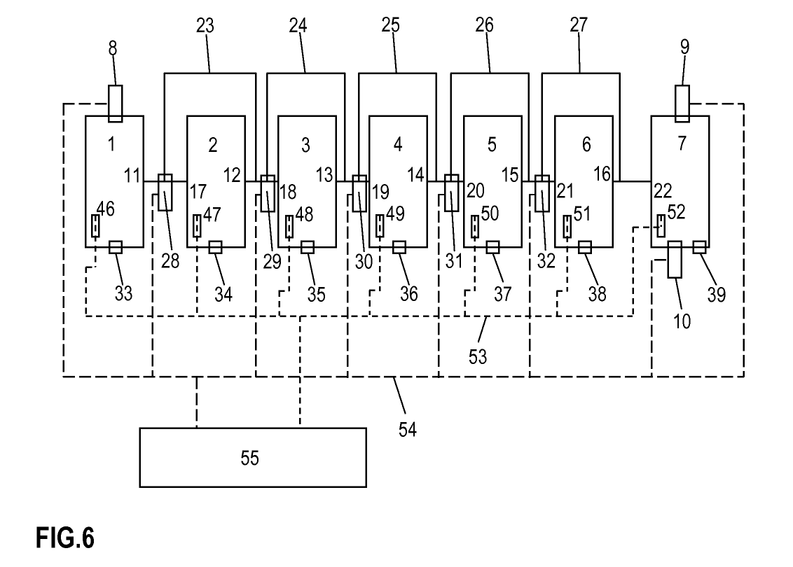

In another embodiment of the present invention, the operation of a stage is controlled electronically by receiving an input signal indicative of an operating parameter collected from within the stage, processing the signal according to criteria, and producing a control signal to change the value of the operating parameter. FIG. 6 shows a control module 55 connected to sensing modules (46, 47, 48, 49, 50, 51, and 52). The control model 55 can be connected to at least one of the sensing module in a stage. The criteria can be pre-existing definitions of actions that is fixed to provide a set of actions based on analyzing and processing one or more of the input signal, or it can be changed over time to include modifications of existing actions or creating new actions during time based on data received from one or more stages or apparatuses of the multi-function water treatment. Further, the criteria can be any logic to respond to an input data and generate an output data facilitated by mechanical, electrical, program, software components, or their combinations.

A sensing model may include at least one sensing element, module, device, or system that generates a signal indicative of an operating parameter such as flow speed, temperature, pressure, current, voltage, electromagnetic wave, capacitance, resistance, vibration, etc. In one application, all operating parameters associated with a function within a stage are deducted by a set of sensors and relayed to the control module (55) via network (53). In the same or another application, all operating parameters are controlled after processing the sensing signals in control module (55) by using components associated with the stage that is responsive to the control signals.

A network (53) provides the connectivity needed between a sensing module associated with a stage and the control module (55). Communication signals transmitted over network (53) can be hydraulic, electrical, electronic, sound, or light based signals. Control module 55 can be program based, algorithm bases, or software based control system. In one application, the control module (55) is computer system running software designed to control all controllable aspects of the multi-function water treatment stages. The controls provided by control module 55 on a stage operation or a flow control apparatus outside a stage can be based on one or more input signals received from the stage, the flow control apparatus, or both. In another embodiment, control module (55) provides at least two distinctive control functions with respect to operation of the multi-function treatment of the present invention. A first control function is controlling operations in one or more stages. The second control function is controlling flow of water solution in one or more apparatuses outside a stage (such as a flow control apparatus).

In one application, FIG. 6 shows control module (55) connected with the flow control apparatus (8, 28, 29, 30, 31, 32, 9, and 10) via communication network 53. Network (53) carries one or more input signals indicative of the operating conditions of one or more of control apparatus (8, 28, 29, 30, 31, 32, 9, and 10) and deliver control (output) signal for one or more of the apparatus (8, 28, 29, 30, 31, 32, 9, and 10) to change the percentages of flow between the stages and the percentage of bypassed flow across the stages. In a similar way, control module (55) can control operation of one or more of flow control apparatus (40, 41, 42, 43, 44) thus changing the flow within flow network (45). Further, control module (55) can control operation of one or more of flow control apparatus (33, 34, 35, 36, 37, 38, and 39).

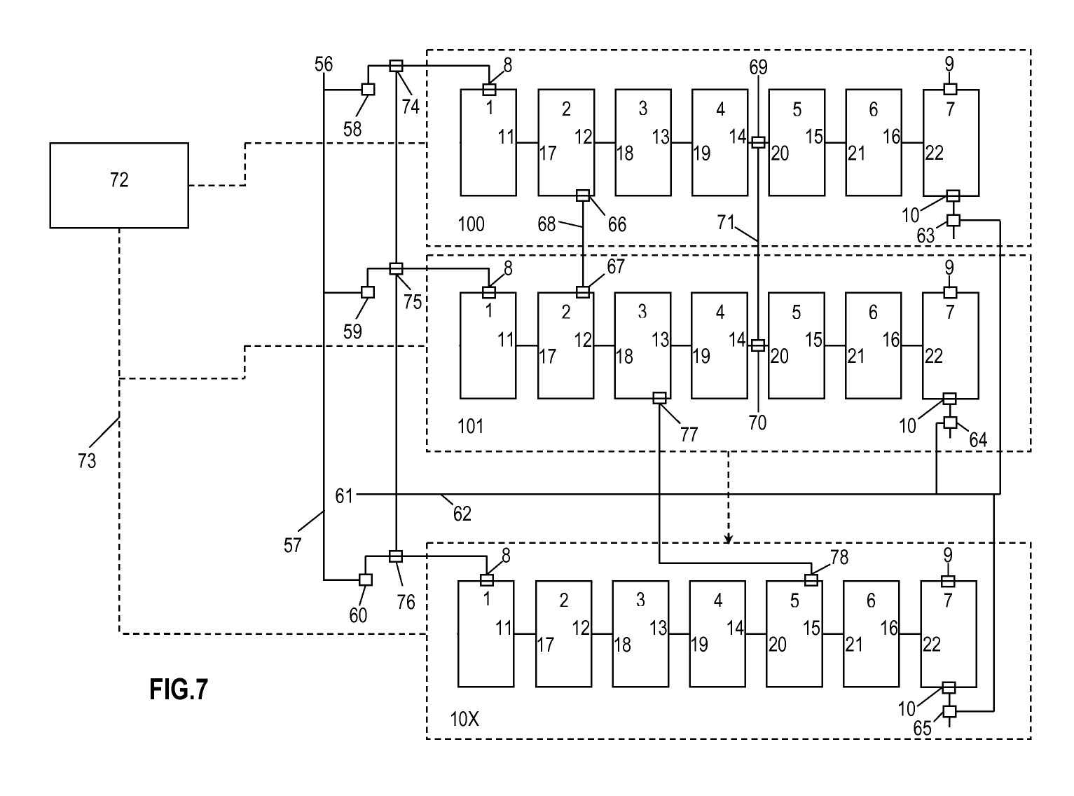

In another embodiment of the present invention, modular applications of the multi-function water treatment are presented in FIG. 7 on the physical, function, and control aspects. FIG. 7 shows more than one (up to n, where n is an integer) of the multi-function water treatment (for example, 100, 101, . . . n=110) where each can act as completely independent station to treat feed water to a specific capacity or a quality of feed water per day. However, while each of the multi-function water treatment (100, 101, . . . 110) is independent, each and every function, stage, or control can be shared between two or more of 100, 101, . . . 110.

The feed water input at an acceptor (56) can be distributed in any percentage into flow control apparatus (8) at 100, 101, and 110 via flow network (57) through flow control apparatus (58, 59, and 60); respectively. The overall output of each module 100 to 110 can be outputted independently or distributed in any percentage into flow network (62) where it pass through a flow controller (76) to result in all output via exit (61) or distribution back to the modules in any percentage via flow controllers (74, 75, and 76).

The water solution flow outputted from a stage in a first module can be transferred to a stage within a second module. For example, the output of stage (2) in module (100) can be transferred into stage (2) via flow network (68) and flow controllers (66, 67). In another example, the flow output of stage (3) in module 101 is transferred to stage (5) in module (110). Furthermore, the water solution within a flow network in a first module can be transferred to a stage or a flow network within a second module. For example, the flow is transferred between flow control apparatus (69) in module 100 and flow control apparatus (70) in module 101.

Furthermore, FIG. 7 shows an embodiment where the stage operation, water solution flow among various flow control apparatuses operation or both operations are shared by a centralized control module (72). Input and control (output) signals are communicated via communication network 73. In one application, control module (72) provides at least two distinctive control functions with respect to operation of the multi-function treatment of the present invention. A first control function is controlling operations in one or more stages within a module (for example 100). The second control function is controlling flow of water solution in one or more apparatuses outside a stage (such as a flow control apparatuses) for example module 100 or 101, or both.

Control module 72 can be program based, algorithm bases, or software based control system. In one application, the control module (72) is computer system running software designed to control all controllable aspects of the multi-function water treatment stages and apparatuses. The controls provided by control module 72 on a stage operation, a flow control apparatus outside a stage, or both can be based on one or more input signals received from the stage, the flow control apparatus, or both. A communication network (73) provides the connectivity needed between a sensing module associated with a stage or a flow control apparatus and the control module (73). Communication signals over network (73) can be hydraulic, electrical, electronic, sound, or light based signals.

What is claimed is:

1. A process for multi-function water treatment of a water solution, the process comprising the following steps:
coagulating the water solution or increasing the rate of coagulation of the water solution, or both, by agglomerating or coagulating one or more contaminants in the water solution for removal by filtration;
filtering the water solution at one or more times after at least one of the steps to produce treated water; and
dispensing reject water.

2. The process of claim 1, further comprising the following steps:
conditioning the water solution;
oxidizing the water solution;
de-foaming the water solution;
clarifying the water solution; and
de-scaling the water solution.

3. The process of claim 2, wherein the water solution is stagnant for a period of time after said conditioning, but prior to said coagulating.

4. The process of claim 1, wherein the flow of the water solution through at least one of the steps is controlled using at least one means for water flow control, wherein the at least one means for water flow control directs a specified amount of water in a continuous flow or stagnation for any predetermined time period.

5. The process of claim 4, wherein the at least one means for water flow control allows one stage within the process to be bypassed.

6. The process of claim 1, further comprising the following steps:
controlling at least one step within the process with electronic means, the electronic means performing pre-existing definitions of actions on at least one of logic responsive to input data, analysis of input signal, time based on data received from one or more stages, or any combination thereof.

7. The process of claim 1 wherein said coagulating comprises reducing the net surface charge of the water solution to a point where ions and colloidal particles are close enough to allow aggregation.

8. The process of claim 1, wherein said coagulating comprises introducing highly charged polymeric metal hydroxide species into the water solution to neutralize the electrostatic charges on suspended solids and droplets within the water solution to facilitate agglomeration or coagulation and resultant separation from the water solution.

9. The process of claim 1, wherein said filtering comprises removing sufficient materials from the water such that the treated water is conditioned for further processing.

10. A process for multi-function water treatment of a water solution, the process comprising the following steps:
conditioning the water to produce conditioned water;
coagulating the conditioned water or increasing the rate of coagulation of the conditioned water, or both to produce coagulated water;
oxidizing the coagulated water to produce oxidized water;
de-foaming the oxidized water to produced de-foamed water;
clarifying the de-foamed water to produce clarified water;
de-scaling the clarified water to produce de-scaled water; and
filtering the water at one or more times after at least one of the steps to produce conditioned feed water, and
wherein the flow of the water through at least one of the steps is controlled using at least one means for water flow control that directs a specified amount of water in a continuous flow or stagnation for any predetermined time period.

11. The process of claim 10, wherein at least one sensor within the at least one means for water control, wherein the at least one means for water control is electronic and receives an input signal indicative of an operating parameter collected from the at least one sensor, and processes the signal according to criteria to produce a control signal to change the value of the operating parameter.

12. The process of claim 11, wherein the at least one sensor generates a signal indicative of at least one operating parameter, including but not limited to flow speed, temperature, pressure, current, voltage, electromagnetic wave, capacitance, resistance, vibrator, or any combination thereof.

13. The process of claim 12, wherein the signal is at least one of hydraulic, electrical, electronic, sound, light-based, or any combination thereof.

14. The process of claim 11,wherein the at least one means for water control controls a pump for moving the water from one step to at least one other step within the process.

15. The process of claim 10, wherein said coagulating the conditioned water or increasing the rate of coagulation of the conditioned water, or both to produce coagulated water uses an electro-coagulation reactor that reduces the net surface charge of the water to a point where ions and colloidal particles can approach closely enough to allow aggregation of the ions and the colloidal particles.

16. The process of claim 15, wherein the electro-coagulation reactor comprises at least one pair of conductive metal plates in parallel acting as electrodes, wherein each plate is made of the same or a different metal.

17. The process of claim 16, wherein the electro-coagulation reactor switches power polarity between the plates at specific time intervals to distribute corrosion evenly among the plates.

18. A multi-function water treatment system for the treatment of water, the system comprising:
a conditioning stage comprising a means for conditioning the water;
a coagulating stage comprising a means for coagulating the water or increasing the rate of coagulation of the water, or both;
an oxidizing stage comprising a means for oxidizing the water;
a de-foaming stage comprising a means for de-foaming the water;
a clarifying stage comprising a means for clarifying the water;
a de-scaling stage comprising a means for de-scaling the water;
one or more means for filtering the water at one or more times after at least one of the stages;
means for dispensing reject water;
pipes connecting each stage to at least one other stage; and
a computerized control device to control the quality, amount, flow direction, and flow rate, entrance, and exit of the water from one stage to another stage or within one or more stages within the system and the operation of at least one means within the system.

19. The multi-function water treatment system of claim 18, wherein the computerized control device allows at least one stage within the system to be bypassed.

20. The multi-function water treatment system of claim 18, further comprising:
at least one sensor coupled to the computerized control device to receive an input signal indicative of an operating parameter collected from the at least one sensor, and wherein the computerized control device processes the signal according to criteria to produce a control signal to change the value of at least one operating parameter in at least one stage.
